(19) United States
(12) Patent Application Publication
(10) Pub. No.: US 2014/0290593 A1
(43) Pub. Date: Oct. 2, 2014

(54) DEVICE AND METHOD FOR GASIFYING BIOMASS

(71) Applicant: Franz Krammer, Koeflach (AT)

(72) Inventor: Franz Krammer, Koeflach (AT)

(73) Assignee: REP RENEWABLE ENERGY PRODUCTS GMBH, Graz (AT)

(21) Appl. No.: 14/232,468

(22) PCT Filed: May 24, 2012
(86) PCT No.: PCT/AT2012/050074

§ 371 Date: Apr. 21, 2014

(30) Foreign Application Priority Data
Jul. 14, 2011 (AT) A 1033/2011

(51) Int. Cl. C10J 3/72; B01D 39/04

(52) U.S. Cl. CPC C10J 3/72; B01D 39/04
USPC 123/2; 55/522; 95/274; 48/111; 48/209

(57) ABSTRACT

The invention relates to a reactor (1) for gasifying biomass, in particular wood, comprising a feeder chute (7) and an ash bed arranged beneath the feeder chute (7). According to the invention, a device is provided by means of which biomass adhering to the feeder chute (7) can be detached, and/or a heat exchanger is provided by means of which a product gas generated from the biomass gives oil heat to the biomass subsequently conveyed in the feeder chute (7) and to oxidation air. The invention further relates to a fine filter (29) for cleaning a product gas generated from biomass. According to the invention, the filter medium contains biomass. Furthermore, the invention relates to a method for gasifying biomass in a reactor (1), in particular a reactor (1) according to the invention, to form a product gas. According to the invention, biomass adhering to the feeder chute (7) is detached and/or heat is given off to biomass and to oxidation air by the product gas.

The invention relates to a reactor for gasifying biomass, in particular wood, comprising a feeder chute and an ash bed arranged beneath the feeder chute.

Furthermore, the invention relates to a fine filter for cleaning a product gas generated from biomass.

In addition, the invention relates to a use of a fine filter of this type.

Furthermore, the invention relates to a method for gasifying biomass in a reactor, in particular in a reactor of the type named at the outset, to form a product gas.

Biomass gasifiers are as such known from the prior art. For example, a device is known from WO 2008/004070 A1 with which biomass, such as wood, straw or biological wastes, is gasified in a reactor and a gas being thereby produced is subsequently guided into a gas-operated motor, where this gas is converted into mechanical energy by combustion. The motor is thereby connected to a generator, with which the mechanical energy is converted into electric energy.

Devices of the prior art have the disadvantages that a system efficiency is only low, since, on the one hand, product gas escapes from the reactor with high temperatures, under which an efficiency of a downstream combustion engine suffers, on the other hand, since a consistency of the biomass frequently leads to adhesions in the reactor so that frequent and expensive maintenances are the result. Furthermore, a high cost for the disposal of filter media that are required for a product gas cleaning also has a negative impact on the system efficiency.

The object of the invention is to remedy or to reduce the disadvantages of the prior art in that a reactor is to be disclosed with which a more efficient method is possible.

In addition, a fine filter is to be disclosed which further increases an efficiency of a method of this type.

An additional object is to disclose a use of a filter of this type.

Furthermore, a method is to be disclosed which remedies or reduces the disadvantages of the prior art.

The first object is attained according to the invention in that, in a reactor of the type named at the outset, a device is provided with which the biomass adhering to the feeder chute can be detached, and/or a heat exchanger is provided with which a product gas generated from the biomass gives off heat to biomass subsequently conveyed in the feeder chute and to an oxidation air.

Because the biomass must be moved at a flow rate through the feeder chute from a first end to a second end during operation, biomass adhering to the feeder chute impedes a motion and thus a proper operation. An advantage of the device with which biomass adhering to the feeder chute can be detached can therefore in particular be seen in that a downtime can be significantly reduced, in which downtime the reactor must be switched off for maintenance purposes. The system efficiency is thus increased for a plant operator.

The heat exchanger with which the heat of the product gas can be transferred to the biomass subsequently conveyed in the feeder chute and to the oxidation air also has in particular the advantage that an energy required for a pyrolysis and for a preheating of the oxidation air can be removed from the product gas so that less energy must be removed from the biomass therefor and a temperature of the product gas can be reduced. If the product gas is immediately processed further in a combustion engine, then a lower temperature increases a thermodynamic efficiency in the combustion engine. A heat transfer from the product gas to the oxidation air and biomass thus has a multiple positive impact on the system efficiency.

It is advantageous that a multi-cover is provided with which a heat of the product gas can be transferred to the oxidation air and subsequently conveyed biomass. Thus, in addition to a mechanically stress-bearing function, this multi-cover also fulfills the function of a heat exchanger, whereby the reactor can be produced in a particularly economical manner. Preferably, the multi-cover is embodied such that said multi-cover has multiple, approximately cylinder-shaped covers positioned approximately concentrically to one another, wherein between a first cover, which forms the feeder chute, and a second cover, which encloses the first cover, product gas can flow from bottom to top in a preferred vertical setup because of thermal buoyancy, and such that a third cover is arranged around this second cover such that the region between the second cover and the third cover can be flowed through by oxidation air. Thus, a heat transfer from the product gas can occur via the first cover or to biomass in the feeder chute and via the second cover to oxidation air, and the temperature of the product gas up to the exit from the multi-cover can be minimized. The multi-cover is preferably composed of steel, wherein the first cover, which is adjacent to the biomass on one side and to the product gas on the other side, is preferably composed of temperature-resistant and acid-resistant material, for example an austenitic chromium-nickel-molybdenum steel. The second cover, which is adjacent to the oxidation air and to the product gas, is preferably only in a lower region made of heat-resistant steel and in an upper region of a normal boiler plate, in order to minimize production costs. It is advantageous if an insulating layer of a heat-insulating material is applied around the third cover, which is preferably likewise composed of steel, in order to prevent a heat of the oxidation air from being given off to an environment.

In order to reduce maintenance times, it is particularly advantageous that a shaking device is provided with which the feeder chute can be moved in vibrations so that adhering biomass can be detached from the feeder chute. Due to broad spectra of possible components and possible consistencies of the biomass, an adhering of biomass to the feeder chute may occur during operation, whereby an operability of the reactor can be markedly impaired. In order to detach possibly adhering biomass in a particularly advantageous manner, the feeder chute can be moved in vibrations by means of the shaking device. The shaking device can be composed of a motor and an unbalanced mass connected to the motor, or other electromagnetic or mechanical devices, wherein vibrations can be transferred to the feeder chute from the shaking device preferably by means of shaped tubes. These shaped tubes can form a direct connection between the shaking device and the feeder chute; however, it can also be provided that the shaking device is indirectly connected to the feeder chute via flexible connection elements. The connection between the shaking device and feeder chute is preferably designed such that temperature-dependent mechanical tensions are minimized in the entire reactor and an imperviousness of the feeder chute is permanently ensured. The shaking device is preferably activated for a duration of a few seconds, preferably for approximately 5 seconds, at regular intervals between 10 and 30 minutes, preferably between 15 and 25 minutes, particularly preferably of 20 minutes.

It has been proven that a wedge gate is provided with which the biomass can be fed to the feeder chute. The biomass can thus be fed to the feeder chute in a particularly simple and energy-efficient manner. The wedge gate thereby preferably comprises a slider plate that is moveably guided in a linear manner in a groove of a frame rigidly connected to the feeder chute. The wedge plate and the frame are thereby preferably components of a lock, via which the biomass is fed to the feeder chute. The connection of the slider plate to the frame preferably occurs in a particularly low-wear manner via one or multiple ball bearings. Other types of bearing are also possible. Because of an acidic atmosphere in the feeder chute, the entire wedge gate, or parts thereof, is designed in an acid-resistant material, preferably an acid-resistant steel.

It is advantageous that a sealed feeder device is provided with which the biomass can be fed to the feeder chute in the absence of oxygen. This is also particularly important in order to not let any undesired gases, in particular oxygen, enter the feeder chute so that it is possible to initiate specifically chemical reactions in the feeder chute, which reactions depend on a controlled or regulated air ratio.

Preferably, it is provided that the feeder chute is embodied in a conically tapered manner in a lower region, in particular with a ratio of a feeder chute cross section to a fire zone cross section of 1.2 to 10, preferably 1.4 to 3, particularly preferably approximately 1.9. In this calculation, the feeder chute cross section is measured in a cylindrical upper region of the feeder chute and the fire zone cross section is measured in a fire zone. Because the biomass changes its volume when moving through the lower region during the pyrolysis occurring in this lower region, it is advantageous if the feeder chute is matched to a volume change of the biomass in order to enable a uniform flow rate of the biomass as well as optimal conditions for the chemical processes taking place. Preferably, a taper angle between a conical axis and a cover surface of the conically embodied lower region is between 20° and 60°, particularly preferably between 30° and 50°, in particular approximately 40°. While the fire zone adjoining this conical region is preferably cylindrically embodied, a lowest region also adjoining the fire zone is preferably likewise conically embodied between the fire zone and a constriction in order to also constructively account for a volume change of the biomass in this lowest region. A taper angle of this lowest region is preferably between 20° and 60°, particularly preferably between 30° and 50°, in particular approximately 40°. This taper angle can also correspond to the taper angle of the lower region.

It has been proven that an oxidation air feed is connected to oxidation air nozzles via an intermediate region and an oxidation air ring, which nozzles flow into a fire zone. The oxidation air can thereby be preheated both in the intermediate region, which is preferably thermally connected to a product gas region, and also in the oxidation air ring, which is preferably thermally connected to the fire zone. A preheating of the oxidation air is thus enabled in a particularly convenient manner. Another advantage can also be seen in that the oxidation air can uniformly enter the fire zone via a circumference of the fire zone and can thus be uniformly distributed in the fire zone.

Using a cross section of the oxidation air nozzles and an air pressure, the air escape rate at the oxidation air nozzles can be influenced particularly advantageously, which rate has a high influence on a chemical reaction in the fire zone. Thus, a higher air escape rate results in a higher temperature in the fire zone; however, a spatial expansion of an ember zone is thereby lower. According to a composition and a calorific value of the biomass, an optimal air intrusion cross section can change. It has been particularly proven that a sum of all cross sections of the oxidation air nozzles corresponds to between 1% and 10%, preferably between 2% and 8%, in particular approximately 4% of a constriction cross section. The constriction cross section is that cross section of the feeder chute at which the biomass can exit the feeder chute to the ash bed.

It has been proven that the oxidation air nozzles are uniformly distributed across a circumference of the fire zone such that a distance of between 2 and 30 cm, preferably between 5 and 20 cm, in particular approximately 10 to 12 cm exists respectively between two oxidation air nozzles on the circumference of the fire zone. The oxidation air nozzles are thereby preferably arranged on a plane; however, an arrangement on multiple planes is likewise possible. Depending on the circumference of the fire zone, there results therefrom a number of oxidation nozzles particularly advantageous to the chemical reaction in the fire zone, as well as an advantageous air velocity.

Preferably, it is also possible that a rotating rack with at least one stirring rod is provided on the ash bed, with which clumps of biomass can be detached. The rotating rack thereby allows a uniform burning-off of the biomass and is also conducive to a removal of ash into an ash bin lying thereunder. A drive of the rotating rack preferably occurs by means of a linear motor via a driving linkage. Other types of drive are also possible. The driving linkage is preferable sealed in a gas-tight manner by means of a stuffing box, which has a temperature-resistant graphite sealing cord for producing a seal-tightness. The at least one stirring rod enables a detaching of the biomass clumping on the rotating rack in a particularly advantageous manner.

It has been proven that sensors are provided with which a pressure before and after the ash bed can be measured in order to use the data obtained in a measurement for a control and/or regulation of the stirring rods. With this arrangement, clumps of biomass on the rotating rack can be detected particularly easily, since clumps result in an increased difference between a pressure before and a pressure after the rotating rack. The stirring rods can thus be activated precisely when additional clumps would lead to problems, and a wear of the stirring rods can be minimized.

In order to produce a product gas from biomass, it is advantageous that the reactor is embodied according to the invention in a device for generating a product gas from biomass comprising a fuel storage for the biomass, a reactor for gasifying the biomass, at least one conveyor element for transporting the biomass from the fuel storage to the reactor, and at least one filter system for cleaning product gas generated from the biomass.

Biomass can thus be transported fully automatically from a fuel storage into the reactor, and the product gas can subsequently be cleaned in a filter system. In particular, because of the particularly efficient reactor, the system efficiency of the entire device is thus better than for devices of the prior art.

Preferably, it is provided that at least one cyclone separator is arranged downstream from the reactor. In the cyclone separator, the product gas is cleaned of dust and fly ash so that the product gas has a higher quality for a further use. Preferably, three cyclone separators connected in parallel are provided, wherein only one cyclone separator or more than three cyclone separators are likewise possible. Multiple cyclone separators can be arranged such that they can be flowed through in parallel or in series by gas, wherein a cyclone separator ash receptacle is arranged such that an ash which can be separated in the at least one cyclone separator is preferably guided automatically into the cyclone separator ash receptacle. In the arrangement of the cyclone separator ash receptacle below the cyclone separator, this is possible in a particularly simple manner. The functional principle of the cyclone separator is known and is based on a centrifugal force, by which dust and fly ash are pressed outwards in the cyclone separator.

It is advantageous that at least one fine filter which contains biomass as a filter medium is downstream from the reactor. This fine filter can be downstream from the cyclone separator, since smaller particles and tar residues can thus also be removed.

It is advantageous that a combustion engine is provided, into which the product gas can be guided, and that the combustion engine is coupled to a generator for generating electric energy. Alternatively to the combustion engine, a different combustion machine, for example a gas turbine, can also be provided. Biomass can thus be converted fully automatically into electric energy.

Preferably, it is provided that a waste heat exchanger is provided with which a heat of an exhaust gas of the combustion engine can be transferred to the biomass for preheating the same. A system efficiency of the entire system is thus further increased, since the heat of the exhaust gas of the combustion engine can also be reused. Of course, it is also possible to use the heat of the exhaust gas of the combustion engine elsewhere, for example for heating purposes.

The second object is attained according to the invention in that a fine filter of the type named at the outside contains biomass as a filter medium. This biomass can preferably contain wood chips according to ÖNORM M7133 G50 or G30 or wood shavings. An advantage of this embodiment is that, after a longer period of use, the filter medium can be transported into the fuel storage and processed in the reactor like biomass so that this filter medium can be recycled in the simplest manner. This filter medium is preferably flowed through from bottom to top by the product gas in the fine filter, wherein contaminants located in the product gas, in particular tar, collect on the biomass. The biomass can thereby be positioned on one or multiple levels. A sensor can also be provided which measures a pressure loss via the filter and thus determines the optimal point in time for a transfer of the contaminated biomass into the fuel storage and a replenishing of the filter with new biomass. Alternatively, a time-based refilling with biomass is also possible.

Of course, a different type of solid biomass can be used instead of wood chips and wood shavings, wherein the filtration effect changes with the filter medium. It is advantageous that the filter medium is positioned on porous perforated bases, preferably perforated metal sheets, on multiple levels in the filter and can be flowed through in series from bottom to top by the product gas. A lowermost layer thereby has approximately 20% wood chips and approximately 80% wood shavings, and an uppermost layer has approximately 70% wood chips and approximately 30% wood shavings. In the layers positioned therebetween, a percentage of wood chips is greater than that of the lowest layer and increases up to the uppermost layer. It is preferred that wood chips and wood shavings are of spruce wood.

The third object is attained in that a filter according to the invention is used for cleaning a product gas generated from biomass, in particular for separating tar. A particularly cost-effective and environmentally friendly type of product gas cleaning can be achieved thereby.

The fourth object is attained according to the invention in that, in a method of the type named at the outset, biomass adhering to the feeder chute is detached and/or heat is given off by the product gas to biomass and an oxidation air.

Through a, in particular intermittent, detaching of biomass adhering to the feeder chute, a contamination of the feeder chute with biomass can be avoided, which biomass would markedly inhibit a functioning. Maintenance times can thus be reduced, and the system efficiency can be increased. Through a transfer of heat from the product gas to biomass and an oxidation air, the amount of energy that exits the reactor in the form of heat in the product gas can be minimized.

Preferably, it is provided that a shaking device is activated for a duration of less than 5 minutes, preferably less than 1 minute, particularly preferably for approximately 5 seconds, at defined intervals, preferably at intervals of 10 to 30 minutes, in particular 15 to 25 minutes, preferably approximately 20 minutes, in order to detach biomass adhering to the feeder chute. Thus, adhering contaminants can be detached in a particularly advantageous manner on the one hand, and, on the other hand, mechanical stresses of a material also remain minimal because of shaking operations so that a long service life of the reactor is achieved.

It is advantageous that a flow rate of the biomass in a lower region of the feeder chute is kept approximately constant by a conical embodiment of the feeder chute in this region. Since the biomass in the lower region changes its volume because of chemical reactions, a conical embodiment of the feeder chute, which results in a uniform flow rate, has a particularly advantageous effect on the framework conditions of these chemical reactions, such as for example pressure or temperature.

It is also advantageous that in a lowermost region of the feeder chute, in particular in the region of a constriction, a temperature is between 1000° C. and 1600° C., in particular 1200° C. and 1500° C., preferably 1220° C. and 1600° C., in more than 50%, in particular more than 70%, preferably more than 90%, of the biomass. A cracking of long-chain hydrocarbons (tars) can thus be ensured, and an accumulation of long-chain hydrocarbons in pipelines and in a possible downstream combustion engine can thus be avoided or at least reduced.

It has been proven that a pressure loss is continuously measured above an ash bed and a stirring device in the ash bed is activated when a predefined limit value is exceeded. Clumps of biomass on the ash bed or on a rotating rack can thus be detected and detached so that a functionality of the device can be ensured.

It is advantageous that the oxidation air flows via an oxidation air ring from an intermediate cover to air nozzles into a fire zone, where an oxidation of biomass is induced. It is thus achieved that the oxidation air is sufficiently preheated so that higher product gas temperatures can be achieved after the oxidation zone. Via the oxidation air ring and the oxidation air nozzles, the air can enter the fire zone in a uniformly distributed manner so that uniform temperatures are achieved.

It is advantageous if a product gas is used to drive a combustion engine and if a generator for generating electric energy is driven using said combustion engine. A fully automatic conversion of chemical energy stored in biomass into electrical energy can thus be achieved in a process in a particularly simple manner.

It is provided that a heat of an exhaust gas of the combustion engine is used for preheating the biomass. An efficiency of the process can thus be further increased since a waste heat of the combustion engine is again fed to the process. Alternatively, this waste heat could also be used for heating purposes or other thermal processes.

Additional features, advantages and effects of the invention result on the basis of the exemplary embodiment illustrated below. In the drawings to which reference is thereby made:

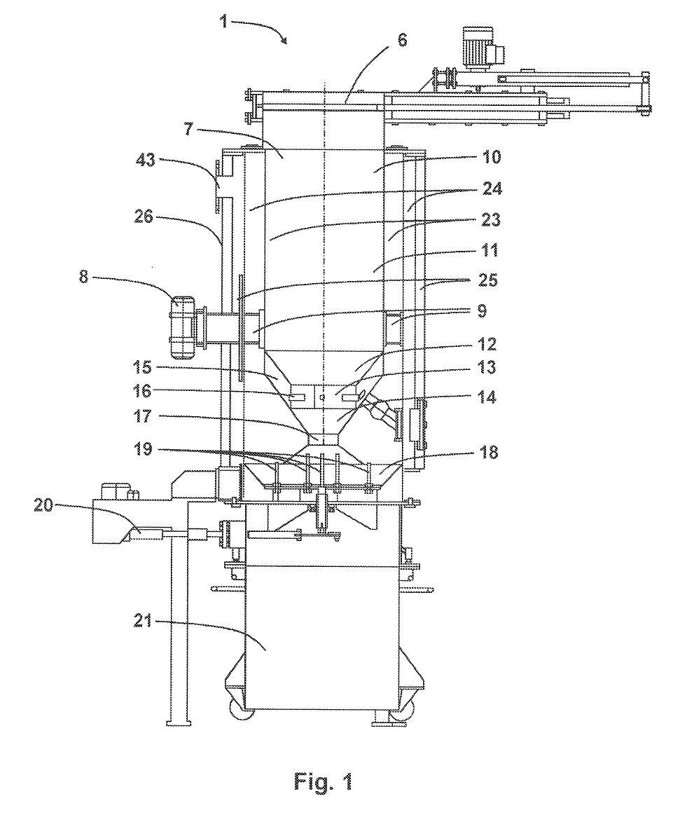

FIG. 1 shows a schematic representation of a reactor according to the invention for gasifying biomass;

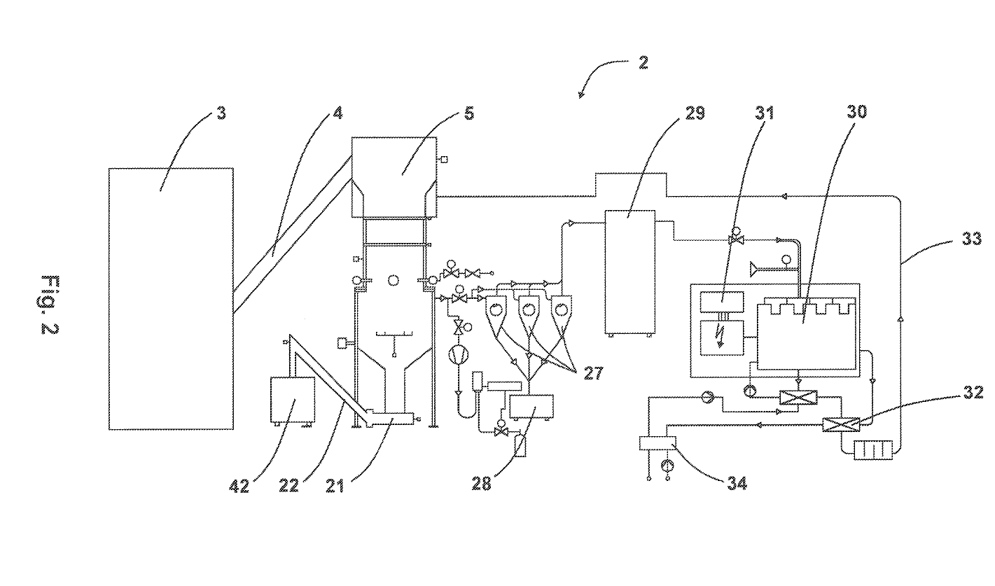

FIG. 2 shows a schematic representation of a device for generating a product gas from biomass;

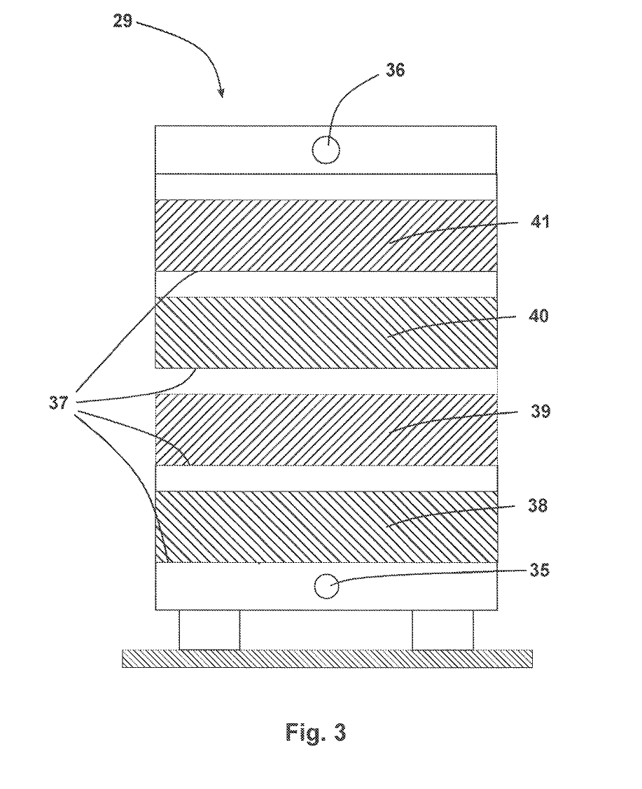

FIG. 3 shows a representation of a fine filter with biomass as a filter medium.

FIG. 1 shows a schematic representation of a reactor 1 for gasifying biomass, in particular wood. Via a lock 6, the biomass can be introduced into the reactor 1 or a feeder chute 7 by a wedge gate at the head end, wherein said feeder chute is sealed in a gas-tight manner by means of a temperature-resistant graphite sealing cord in order to be able to precisely control an oxygen content in the reactor 1. The wedge gate is embodied with position sensors so that, for an automatic operation, a current position of a slider plate can be determined at any time. A driving of the slider plate occurs by means of an electric motor. Side-mounted on the reactor 1 is a shaking device 8 with which biomass adhering to the feeder chute 7 can be detached. For this purpose, a shaking motion can be transferred from the shaking device 8 to the feeder chute 7 via one or multiple shaped tubes 9. A transfer of the shaking motion is also possible using other constructional components in place of a shaped tube 9, for example mechanically weaker or more rigid components, in order to achieve an optimal shaking result. In the reactor 1 shown in the exemplary embodiment, the shaking device 8 is activated for approximately 5 seconds at regular intervals every 20 minutes in order to detach adhering biomass from the feeder chute 7. The choice of longer intervals between the shaking intervals and longer shaking intervals is likewise possible, as well as the choice of shorter times for these intervals. The regulation of the shaking device 8 via a sensor is also possible, which sensor detects a volume or a weight of an adhering biomass and activates the shaking device 8 in a manner adapted thereto. Alternatively, it is also possible to detach adhering biomass by means of another mechanical method, such as for example direct or indirect impact using a solid, liquid or gaseous medium.

The feeder chute 7 is formed by a first cover 23 in which the biomass is moved from a first end in an upper region 10 to a constriction 17 by means of gravity during operation. During the motion, chemical processes take place in the biomass. Because of the chemical processes and the chemical components produced thereby, the first cover 23 is, at least in the lower region 12, made from an austenitic chromium-nickel-molybdenum steel. Alternatively thereto, other heat-resistant and acid-resistant materials can be used. The first cover 23, which is cylindrical in the upper region 10 and a middle region 11, is thereby enclosed by a second cover 24 positioned concentrically thereto. This second cover 24 is also enclosed by a third cover 25 positioned concentrically thereto. On an outside of the third cover 25, an insulation layer 26 composed of heat-insulating material is arranged, which insulation layer minimizes a heat transfer from oxidation air to an environment. The first cover 23, second cover 24 and third cover 25, which are preferably composed of steel, are essentially rotationally symmetrical; the second cover 24 and third cover 25 are essentially embodied in a consistently cylindrical manner. In the lower region 12 and a lowermost region 14 of the feeder chute 7, the first cover 23 is partially cylindrically embodied, wherein an angle between a cone axis and a cone envelope is approximately 40°. The conical embodiment is thereby interrupted by a cylindrically embodied fire zone 13 and ends at a constriction 17, at which the biomass can exit the feeder chute 7 to an ash bed during operation. A constriction ratio of a fire zone cross section to a feeder chute cross section is approximately 1:1.9, wherein the constriction ratio is formed with the cross section of the feeder chute 7 in the cylindrical upper region 10. This constriction ratio and the angle are dependent upon a composition of the biomass and can, depending the application, also be smaller or larger. Thus, the constriction ratio is approximately 1:1.8 for softwood as a main component of the biomass and approximately 1:2 for hardwood as a main component of the biomass. However, this can increase or decrease depending on the biomass used or wood type used. Thus, constriction ratios of 1:4 to 1:1.1 are possible depending on the application.

In the lower region 12 of the feeder chute 7, an oxidation air ring 15 is arranged around the feeder chute 7, which ring is connected to the intermediate region via an expansion joint which can compensate for thermal expansions. From the oxidation air ring 15, oxidation air nozzles 16 project into the fire zone 13 on a plane. In the exemplary embodiment, the number of the oxidation air nozzles 16 is chosen such that a distance of approximately 10 to 12 cm between the center points of the oxidation air nozzles 16 remains in a circumferential direction over a circumference of the fire zone 13. The cross section of the oxidation air nozzles 16 is thereby chosen such that the sum of all cross sections corresponds to approximately 4% of a constriction cross section. However, the functioning also occurs, at least in a limited manner, with other cross-sectional ratios, for example 1% to 20%, or distances between the oxidation air nozzles 16, for example 1 to 30 cm. The constriction cross section is that smallest cross section of the feeder chute 7 via which the biomass exits the feeder chute 7 to the ash bed.

Below the constriction 17, the ash bed is located onto which the biomass falls after passing through the reactor 1. The ash bed thereby comprises a rotating rack 18, which is connected to a motor, preferably a linear motor 20, via a driving linkage and can be driven by said motor. A gas-tight implementation of the driving linkage from the rotating rack 18 to the motor positioned outside the reactor 1 is achieved by a stuffing box, which is sealed by a temperature-resistant graphite sealing cord.

On the rotating rack 18, stirring rods 19 are arranged with which biomass adhering to the rotating rack 18 can be detached. Adhering biomass impedes an ash removal into an ash bin 21 arranged below the rotating rack 18 and limits an unhindered outflow of the product gas by an increased pressure loss at the rotating rack 18. Using a pressure-difference measurement, the optimal point in time is determined at which the stirring rods 19 are activated and biomass is detached from the rotating rack 18. A functioning of the reactor 1 is thus continuously monitored.

During operation, a product gas flows upwards from the constriction 17 out of the reactor 1 in a space between the first cover 23 and the second cover 24. In the space between the second cover 24 and the third cover 25, an oxidation air flows from an oxidation air feed 43 to an oxidation air ring 15. In the feeder chute 7, biomass is located which is introduced into the feeder chute 7 by the wedge gate and passes through said feeder chute from top to bottom. The product gas thereby gives off heat to the biomass located in the feeder chute 7 via the first cover 23 and to the oxidation air via the second cover 24. Biomass adhering to the feeder chute 7 is detached in that the shaking device 8 is activated for 5 seconds after 20 minutes respectively. The biomass is dried and preheated in the upper region 10 of the feeder chute 7 by a heat of the product gas. In the middle region 11, the pyrolysis begins, in which, among other things, organic acids such as ethanoic acid, methyl alcohol and tar are produced in the course of a thermal decomposition. In addition, in this middle region 11, hemicellulose, which is possibly contained in the biomass, decomposes at a temperature of 200° C. to 300° C. With further heating, cellulose contained in the biomass is cracked between 325° C. and 375° C., and carbon dioxide, methane and organic acids, in particular ethanoic acid, are produced. With a further temperature increase above 375° C., lignin breaks into smaller chemical compounds. In addition, hydrocarbons and tars are produced in this middle region 11. In a lower region 12 of the feeder chute 7, the oxidation of the biomass begins. A constant flow rate and a high pressure, which are achieved in this region via the conical embodiment of the feeder chute 7 because of a falling solid volume of the biomass, are required in order to ensure an optimal oxidation process. In the fire zone 13, the oxidation air is fed to the biomass via the oxidation air nozzles 16, and substoichiometric carbon and hydrogen combust with an energy output. A temperature is thereby approx. 650° C. to 850° C., wherein carbon dioxide, water and methane are produced. A temperature range can be controlled in a particularly advantageous manner via the amount of the fed oxidation air and a rate at which the oxidation air enters. Below the fire zone 13, a chemical reduction takes place in the lowermost region 14 of the feeder chute 7. Here, the production of flammable gas is enabled by a gasification of carbon, among other things. In this lowermost region 14, the intermediate products produced during the oxidation, such as carbon dioxide and water, are reduced at hot locations, wherein carbon monoxide, hydrogen and higher hydrocarbons are produced. Because of the particular embodiment of the reactor 1 in this lowermost region 14, ideal temperatures between 1220° C. and 1470° C. are achieved here, in particular also in the region of the constriction 17, which temperatures are close to the ash melting point of the biomass. A limited functioning is also possible within a temperature range of 1000° C. to 1600° C. Through the conical embodiment of the feeder chute 7 in the lowermost region 14, a constant temperature can be achieved, in particular in the region of the constriction 17, across a large part of the volume of the biomass, with which temperature a cracking of long-chain hydrocarbons (tars) is ensured and accumulations of tars, in particular in pipelines, are thus minimized. Because of the temperature close to an ash melting point of biomass, biomass adhering to the rotating rack 18 occurs during operation, which biomass is detached with the stirring rods 19. Because the correct choice of stirring intervals or pauses between the stirring intervals is relevant in order to produce an optimal result of the chemical reaction in the reduction zone, the stirring rods 19 are activated exactly to the degree that is necessary to detach adhering biomass. For this purpose, a pressure difference is measured before and after the rotating rack 18 and these values are used for a regulation of the stirring rods 19. By means of a motion of the rotating rack 18, ash is removed into the ash bin 21 in a particularly advantageous manner, from where said ash is automatically transported into an ash storage container 42 by means of an ash conveyor 22. In this process, there results a gas yield of up to 2 standard cubic meters of product gas per kilogram of fed biomass.

FIG. 2 shows a device 2, in which the reactor 1 is embedded, for generating a product gas from biomass. The biomass can thereby be transported from a fuel storage 3 into the reactor 1 via a biomass dryer 5 by means of a conveyor element 4. A gas outlet of the reactor 1 is connected to cyclone separators 27, where the product gas can be cleaned of dust and fly ash. Three parallel cyclone separators 27 are thereby provided which can be flowed through by gas in a uniform and parallel manner. In the cyclone separators 27, the product gas can be guided in a circular path at a very high speed so that, because of a centrifugal force, dust and ash are pushed radially outwards, from where said dust and ash can be removed downwards into a cyclone separator ash receptacle 28.

Downstream from the cyclone separator 27 is a fine filter 29 in which the product gas is cleaned by means of wood chips and wood shavings. A particular advantage of the wood chips as a filter material in this fine filter 29 is that the wood chips, once they are saturated with contaminants, can be fed to the fuel storage space and thus be directly recycled. In this manner, no filter wastes whatsoever are produced. Preferably, the fine filter 29 is embodied such that said fine filter can be flowed through from bottom to top by the product gas during operation, wherein dirt and tar can collect on the wood chips. A pressure sensor can be provided, via which an optimal point in time for emptying this filter can be determined. Alternatively, a purely time-based emptying of the filter would also be possible.

As gas outlet of the fine filter 29 is connected to a four-cylinder gasoline engine or, generally, a combustion engine 30 which drives a generator 31 and can thus convert the energy of the gas into electric energy. Alternatively, the use of a gas turbine or other machines is also possible which can convert a chemical energy of a product gas into mechanical energy and subsequently into electric energy. Downstream from the gas engine is a waste heat exchanger 32 which makes a waste heat of the gas engine usable for the preheating of the biomass, as well as for possible heating applications. In FIG. 2, a biomass preheating line 33 can also be recognized from which at least a part of the residual heat of the product gas can be used for the preheating of biomass in the biomass dryer 5. A heat accumulator 34 is also provided for an intermediate storage of waste heat.

The method for cleaning product gas obtained from the biomass and a further processing into electric energy functions with the device 2 such that the biomass from the fuel storage 3 is fed to the feeder chute 7 via the lock 6 by means of the conveyor element 4. The biomass is subsequently gasified to form product gas in the reactor 1 as described above. After exiting the reactor 1, the product gas is cleaned in the cyclone separators 27 and in the fine filter 29 before it is guided into the combustion engine 30. There, the chemical energy of the gas is converted into mechanical energy, which is subsequently converted into electric energy in a generator 31. The gas engine is thereby regulated to an air ratio of lambda equals 1.15 during the combustion of the product gas. Particularly advantageous contaminant levels are thus achieved in the exhaust gas. A waste heat of the combustion engine 30 is given off to a heat transfer medium via the waste heat exchanger 32 and partially intermediately saved in the heat accumulator 34 for heating purposes and partially used for drying the biomass in the biomass dryer 5 via the biomass preheating line 33 prior to entry into the reactor 1. In this method, a high maintenance and disposal cost is avoided in that the feeder chute 7 is regularly cleaned of adhering biomass by shaking and the feeder chute 7 is cleaned of clumps by regular stirring with stirring rods 19, and in that contaminated wood chips in the fine filter 29 can be recycled in a particularly advantageous manner by a return to the fuel storage 3.

FIG. 3 shows a representation of the fine filter 29 in which biomass is used as a filter material. The product gas can thereby enter the fine filter 29 at a lower end via a product gas inlet 35. The filter medium is thereby distributed to perforated bases 37 on four layers 38, 39, 40, 41, through which bases the product gas can flow. The perforated bases 37 are thereby preferably embodied of metal sheets with a plurality of holes; however, a different type of a porous base can also be chosen that is preferably embodied in a temperature-resistant manner. Of course, the use of only a single layer or the use of more than four layers is also alternatively possible. During operation, the product gas thereby flows through the fine filter 29 from bottom to top through the individual levels in series until it exits the fine filter 29 in a cleaned state at the product gas outlet 36. During the flowing-through of the individual layers, particles located in the product gas, in particular tars, dust and contaminants, are largely accumulated on the filter material. The filter medium of layer 38 is thereby composed of 20% wood chips and 80% wood shavings, the filter medium of layer 39 of 30% wood chips and 70% wood shavings, the filter medium of layer 40 of 50% wood chips and 50% wood shavings, and the filter medium of layer 41 of 70% wood chips and 30% wood shavings. The wood chips and wood shavings are preferably made of spruce wood; however, a use of other types of biomass is also conceivable, wherein a filter performance depends on the biomass used. A particular advantage of the use of biomass as a filter medium is that, after contamination in the fme filter 29, the biomass can be fed to the fuel storage 3 and can thus be recycled in the simplest manner. An optimal point in time for replacing the filter media because of contamination can be determined via a measurement of pressure difference, wherein a pressure loss is measured via the fine filter 29. Alternatively, a purely time-based replacement of the filter media is also possible. If the filter media are replaced based on time, a replacement after approximately 100 operating hours is recommended.

1. Reactor (1) for gasifying biomass, in particular wood, comprising a feeder chute (7) and an ash bed arranged beneath the feeder chute (7), characterized in that a device is provided with which biomass adhering to the feeder chute (7) can be detached and/or a heat exchanger is provided with which a product gas generated from the biomass gives off heat to a biomass subsequently conveyed in the feeder chute (7) and to an oxidation air.

2. Reactor (1) according to claim 1, characterized in that a multi-cover is provided with which a heat of the product gas can be transferred to the oxidation air and subsequently conveyed biomass.

3. Reactor (1) according to claim 1, characterized in that a shaking device (8) is provided with which the feeder chute (7) can be moved in vibrations so that adhering biomass can be detached from the feeder chute (7).

4. Reactor (1) according to claim 1, characterized in that a wedge gate is provided with which the biomass can be fed to the feeder chute (7).

5. Reactor (1) according to claim 1, characterized in that a sealed feeder device is provided with which the biomass can be fed to the feeder chute (7) in the absence of oxygen.

6. Reactor (1) according to claim 1, characterized in that the feeder chute (7) is embodied in a conically tapered manner in a lower region (12), in particular with a ratio of a feeder chute cross section to a fire zone cross section of 1.2 to 10, preferably 1.4 to 3, particularly preferably approximately 1.9.

7. Reactor (1) according to claim 1, characterized in that an oxidation air feed (43) is connected to oxidation air nozzles (16) via an intermediate region and an oxidation air ring (15), which nozzles flow into a fire zone (13).

8. Reactor (1) according to claim 1, characterized in that a rotating rack (18) with at least one stirring rod is provided on the ash bed, with which clumps of biomass can be detached.

9. Reactor (1) according to claim 8, characterized in that sensors are provided with which a pressure before and after the ash bed can be measured in order to use data obtained in a measurement for a control and/or regulation of the stirring rods (19).

10. Device (2) for generating a product gas from biomass comprising a fuel storage (3) for the biomass, a reactor (1) for gasifying the biomass, at least one conveyor element (4) for transporting the biomass from the fuel storage (3) into the reactor (1), and at least one filter system for cleaning product gas generated from the biomass, characterized in that the reactor (1) is embodied according to claim 1.

11. Device (2) according to claim 10, characterized in that at least one cyclone separator (27) is arranged downstream from the reactor (1).

12. Device (2) according to claim 10, characterized in that at least one fine filter (29) which contains biomass as a filter medium is downstream from the reactor (1).

13. Device (2) according to claim 10, characterized in that a combustion engine (30) is provided, into which the product gas can be guided, and in that the combustion engine (30) is coupled to a generator (31) for generating electric energy.

14. Device (2) according to claim 13, characterized in that a waste heat exchanger (32) is provided with which a heat of an exhaust gas of the combustion engine (30) can be transferred to the biomass for preheating the same.

15. Fine filter (29) for cleaning a product gas generated from biomass, characterized in that the filter medium contains biomass.

16. Use of a fine filter (29) according to claim 15 for cleaning a product gas generated from biomass, in particular for separating tar.

17. Method for gasifying biomass to form a product gas in a reactor (1), in particular a reactor (1) according to claim 1, characterized in that biomass adhering to the feeder chute (7) can be detached and/or in that heat is given off to biomass and an oxidation air by the product gas.

18. Method according to claim 17, characterized in that a shaking device (8) is activated for a duration of less than 5 minutes, preferably less than one minute, particularly preferably for approximately 5 seconds, at defined intervals, preferably at intervals of 10 to 30 minutes, in particular 15 to 25 minutes, preferably approximately 20 minutes, in order to detach biomass adhering to the feeder chute (7).

19. Method according to claim 17, characterized in that a flow rate of the biomass in a lower region (12) of the feeder chute (7) is kept approximately constant by a conical embodiment of the feeder chute (7) in this region.

20. Method according to claim 17, characterized in that in a lowermost region (14) of the feeder chute (7), in particular in the region of a constriction (17), a temperature between 1000° C. and 1600° C., in particular 1200° C. and 1500° C., preferably 1220° C. and 1470° C., is in more than 50%, in particular more than 70%, preferably more than 90%, of the biomass.

21. Method according to claim 17, characterized in that a pressure loss is continuously measured above an ash bed and a stirring device is activated in the ash bed when a predefined limit value is exceeded.

22. Method according to claim 17, characterized in that the oxidation air flows via an oxidation air ring (15) from the intermediate cover to air nozzles in a lower region (12) of the feeder chute (7), where an oxidation of biomass is induced.

23. Method according to claim 17, characterized in that a product gas is used for driving a combustion engine (30) and a generator (31) for generating electric energy is driven by said combustion engine.

24. Method according to claim 23, characterized in that a heat of an exhaust gas of the combustion engine (30) is used for preheating the biomass.
